(19) United States
(12) Patent Application Publication
(10) Pub. No.: US 2017/0223514 A1
(43) Pub. Date: Aug. 3, 2017

(54) SENSOR-BASED ACTION CONTROL FOR MOBILE WIRELESS TELECOMMUNICATION COMPUTING DEVICES

(71) Applicant: OverAir Proximity Technologies Ltd., Hamilton (CA)

(72) Inventors: Quoc Nam Do, Mississauga (CA); Vighram Jogarasan, Hamilton (CA)

(21) Appl. No.: 15/394,614

(22) Filed: Dec. 29, 2016

Related U.S. Application Data
(60) Provisional application No. 62/289,141, filed on Jan. 29, 2016.

(51) Int. Cl. H04W 4/20; H04W 40/24; H04W 4/00

(52) U.S. Cl. CPC H04W 4/206; H04W 4/008; H04W 40/244; H04L 67/146

(57) ABSTRACT

The present disclosure describes systems and methods in which one or more existing onboard sensors on a mobile wireless telecommunication computing device, such as a smartphone, are recruited to detect a condition in which an action should be initiated, and the mobile wireless telecommunication computing device uses a wireless signal to identify the desired action. For example, a magnetometer on a smartphone may be used to detect the presence of a nearby magnet as a condition in which an action should be initiated, or an accelerometer and gyroscope on a smartphone may be used to detect a gesture as a condition in which an action should be initiated. Other sensors may also be used to detect other conditions. The approach may be advantageously applied to pull marketing, although it is not limited to such applications.

### TECHNICAL FIELD

The present disclosure relates to wireless communication signals, and more particularly to receiving and acting on wireless communication signals.

### BACKGROUND

The term “pull” marketing refers broadly to an interactive and targeted method of marketing to consumers. As opposed to so-called “push” marketing where advertisements are broadly “pushed” to consumers, pull marketing allows consumers to request additional information for items of interest, i.e. to “pull” additional marketing materials toward them. Thus, pull marketing is dictated by consumer needs, providing a more targeted marketing approach. The advent of networked mobile wireless telecommunication devices, such as smartphones, has brought pull marketing to the forefront. In a simple embodiment, an advertisement can provide a uniform resource locator (URL), and the user can manually enter the URL into the browser to obtain additional information. QR codes eliminate the need for manual entry of a URL by automatically directing a browser to a predefined URL when scanned, but still require a user to approach in sufficiently close proximity to the QR code, activate an application used to scan the QR code, and then position the device so that the camera captures the QR code. These methods can be cumbersome and are not always successful in convincing consumers to retrieve information that may otherwise be desired.

### SUMMARY

Broadly speaking, the present disclosure describes systems and methods in which one or more existing onboard sensors on a mobile wireless telecommunication computing device, such as a smartphone, are recruited to detect a condition in which an action should be initiated, and the mobile wireless telecommunication computing device uses a wireless signal to identify the desired action. The approach may be advantageously applied to pull marketing, although it is not limited to such applications.

In one aspect, a method for initiating an action comprises executing, in a processor of a mobile wireless telecommunication computing device, a listening application. The listening application causes the processor to monitor a sensor signal feed from a sensor, other than a camera, on the mobile wireless telecommunication computing device. The listening application causes the processor to, responsive to receiving a sensor signal in the sensor signal feed conforming to a predetermined signal, determine an action to be performed by the mobile wireless telecommunication computing device. The processor determines the action to be performed by the mobile wireless telecommunication computing device from a wireless communication signal received by the mobile wireless telecommunication computing device, and causes the mobile wireless telecommunication computing device to perform the action.

In some embodiments, the sensor signal feed is a magnetometer signal feed from a magnetometer on the mobile wireless telecommunication computing device, and the predetermined signal is exceeding a predetermined magnetometer threshold.

In some embodiments, the wireless communication signal is a short-range wireless communication signal received from a nearest beacon, the short-range wireless communication signal contains a beacon identifier for the nearest beacon, and the processor determines the action to be performed by the mobile wireless telecommunication computing device from the beacon identifier. The processor may identify the nearest beacon from a plurality of nearby beacons by triangulation. The processor may determine the action to be performed by the mobile wireless telecommunication computing device from the beacon identifier by using the beacon identifier to identify the action to be performed by the mobile wireless telecommunication computing device from a database. In some embodiments, the mobile wireless telecommunication computing device is coupled to a network, and the database is a remote database coupled to the network. In some such embodiments, the processor further uses an identifier for the mobile wireless telecommunication computing device to identify the action to be performed by the mobile wireless telecommunication computing device from the database.

In some embodiments, the action to be performed by the mobile wireless telecommunication computing device consists of a predetermined operation performed using at least one predetermined value, and the processor identifies at least the at least one predetermined value from the database. In one particular embodiment, the predetermined operation is opening a web page in a browser, and the predetermined value is a uniform resource locator (URL).

In another aspect, a beacon comprises a housing carrying a BLE unit, a beacon processing unit coupled to the BLE unit and adapted to control the BLE unit, a beacon storage coupled to the beacon processing unit, wherein the beacon storage stores an identifier for the beacon, a power source adapted to power the beacon, and a magnet having a strength of at least 70 microteslas (0.70 gauss). Preferably, the magnet has a strength of at least 75 microteslas (0.75 gauss), and more preferably, the magnet has a strength of at least 85 microteslas (0.85 gauss).

In a further aspect, a method for initiating an action comprises executing, in a processor of a mobile wireless telecommunication computing device, a listening application. The listening application causes the processor to monitor at least a first sensor signal feed from a first sensor on the mobile wireless telecommunication computing device and a second sensor signal feed from a second sensor on the mobile wireless telecommunication computing device. The first sensor and the second sensor may be selected from the group consisting of magnetometer, accelerometer, gyroscope, light sensor and microphone and excluding camera. The listening application causes the processor to, responsive to receiving at least a first predetermined signal in the first sensor signal feed and a second predetermined signal in the second sensor signal feed, determine an action to be performed by the mobile wireless telecommunication computing device. The processor determines the action to be performed by the mobile wireless telecommunication computing device from a wireless communication signal received by the mobile wireless telecommunication computing device, and causes the mobile wireless telecommunication computing device to perform the action.

In some embodiments, the wireless communication signal is a short-range wireless communication signal received from a nearest beacon, the short-range wireless communication signal contains a beacon identifier for the nearest beacon, and the processor determines the action to be performed by the mobile wireless telecommunication computing device from the beacon identifier. The processor may identify the nearest beacon from a plurality of nearby beacons by triangulation.

The processor may determine the action to be performed by the mobile wireless telecommunication computing device from the beacon identifier by using the beacon identifier to identify the action to be performed by the mobile wireless telecommunication computing device from a database. In some embodiments, the mobile wireless telecommunication computing device is coupled to a network, and the database is a remote database coupled to the network. In some such embodiments, the processor further uses an identifier for the mobile wireless telecommunication computing device to identify the action to be performed by the mobile wireless telecommunication computing device from the database.

In some embodiments, the action to be performed by the mobile wireless telecommunication computing device consists of a predetermined operation performed using at least one predetermined value, and the processor identifies at least the at least one predetermined value from the database. In one particular embodiment, the predetermined operation is opening a web page in a browser, and the predetermined value is a uniform resource locator (URL).

The summary is not intended to be exhaustive or limiting; further aspects of the technology are set out in the detailed description.

### BRIEF DESCRIPTION OF THE DRAWINGS

These and other features will become more apparent from the following description in which reference is made to the appended drawings wherein:

FIG. 1 shows an exemplary smartphone, which may be used in implementing various methods described herein;

FIGS. 2 and 2A show exemplary beacons;

FIGS. 3 and 3A are flow charts showing a first exemplary method for initiating an action, with FIG. 3 showing a particular implementation of a method shown more generally in FIG. 3A;

FIGS. 4A and 4B show exemplary beacons according to the present disclosure; and

FIG. 5 is a flow chart showing a second exemplary method for initiating an action.

### DETAILED DESCRIPTION

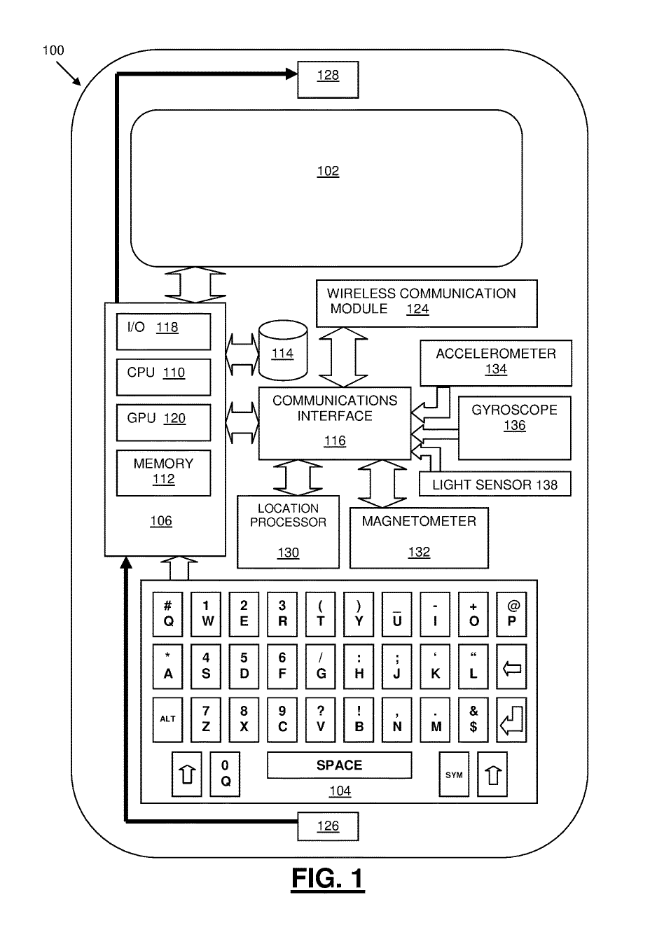

FIG. 1 shows an exemplary mobile wireless telecommunication computing device in the form of a smartphone 100. The smartphone 100 includes a display 102, an input device in the form of keyboard 104 and an onboard computer system 106. The display 102 may be a touchscreen display and thereby serve as an additional input device, or as an alternative to the keyboard 104. The onboard computer system 106 comprises a central processing unit (CPU) 110 having one or more processors or microprocessors for performing arithmetic calculations and control functions to execute software stored in an internal memory 112, preferably random access memory (RAM) and/or read only memory (ROM). The onboard computer system 106 may be coupled to additional memory 114 which will typically comprise flash memory, which may be integrated into the smartphone 100 or may comprise a removable flash card, or both. The smartphone 100 also includes a communications interface 116 which allows software and data to be transferred between the smartphone 100 and external systems and networks. The communications interface 116 is coupled to one or more wireless communication modules 124, which will typically comprise a wireless radio for connecting to one or more of a cellular network, a wireless digital network or a Wi-Fi network. In operation, the smartphone 100 will usually be coupled to a cellular network, and possibly also to a wireless digital network or a Wi-Fi network, making the smartphone 100 a networked mobile wireless telecommunication computing device. The communications interface 116 will also typically enable a wired connection of the smartphone 100 to an external computer system. A microphone 126 and speaker 128 are coupled to the onboard computer system 106 to support the telephone functions managed by the onboard computer system 106, either directly as shown or via the communications interface 116. A location processor 130 (e.g. including GPS receiver hardware) and magnetometer 132 may also be coupled to the communications interface 116 to support navigation operations by the onboard computer system 106; the magnetometer functions as an electronic compass and gathers data used to determine the direction of magnetic North. An accelerometer 134 and gyroscope 136 are coupled to the communications interface 116 to gather data about movement of the smartphone 100. A light sensor 138 is also coupled to the communications interface 116. Input and output to and from the onboard computer system 106 is administered by the input/output (I/O) interface 118, which administers control of the display 102, keyboard 104, microphone 126, and speaker 128. The onboard computer system 106 may also include a separate graphical processing unit (GPU) 120. Additional components, such as one or more cameras (e.g. a front facing camera and/or a rear facing camera), may also be included as part of the smartphone 100 and coupled to the communications interface 116. The various components are coupled to one another either directly or by coupling to suitable buses. It is to be understood that the above description is intended to provide an overview of the components and operations of the exemplary smartphone 100 and therefore omits and/or simplifies certain aspects which are known to one skilled in the art.

BLUETOOTH® Low Energy technology (BLE), also referred to as Bluetooth Smart technology, was introduced as part of the Bluetooth 4.0 specification, and is designed to enable wireless communication by devices which must rely on a small battery for an extended period of time. The Bluetooth 4.0 specification, and its successor the Bluetooth 4.1 specification, both promulgated by the Bluetooth Special Interest Group (Bluetooth SIG), having an address in the United States at 5209 Lake Washington Blvd NE, Suite 350, Kirkland, Wash., 98033, U.S.A., are hereby incorporated by reference in their entirety.

One application of BLE is in the field of beacons. The term “beacon”, as used herein, refers to wireless proximity devices incorporating a BLE unit to transmit data packets of fixed length and format and including identifying information, which can be received by a compatible BLE-enabled receiving device, such as a suitable smartphone or tablet (among others) and used to determine relative proximity between the proximity device and the receiving device. A BLE unit comprises a microchip and antenna configured to transmit the data packet as a BLE-compliant low power radio signal. The transmitted radio signal containing the data packet is referred to as an “advertisement.” Software executing on the receiving device can be configured to receive and process an advertisement from a beacon to determine relative proximity to that beacon, and further configured to perform predetermined actions upon detecting specified proximity to particular beacons. The proximity of a beacon to a receiver is determined based on relative signal strength, and in present implementations is categorized as “immediate,” “near,” “far,” and “unknown.”

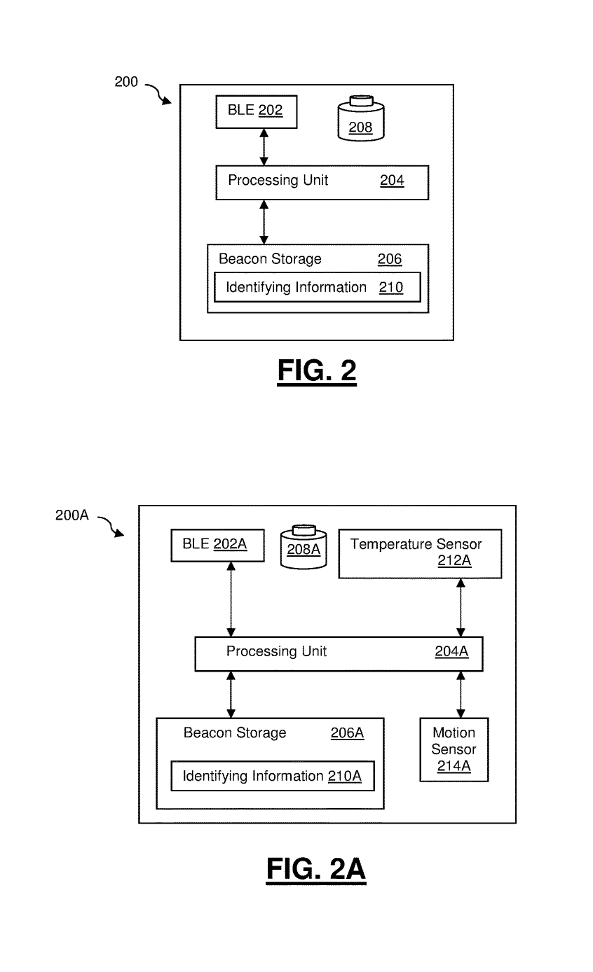

Referring now to FIG. 2, a first exemplary beacon is indicated generally at 200. The exemplary beacon 200 indicates a beacon its most basic form, which comprises a BLE unit 202 adapted to send and receive BLE radio signals, a beacon processing unit 204 coupled to the BLE unit 202 and adapted to control the BLE unit 202, a beacon storage 206 coupled to the beacon processing unit 204 and a power source 208, typically a battery, adapted to provide power to the beacon. The beacon storage 206 contains the identifying information 210 for the beacon 200. During normal operation, the beacon processing unit 204 retrieves the identifying information 210 for the beacon 200 and causes the BLE unit 202 to periodically transmit the advertisement containing the identifying information 210 for the beacon 200 (referred to as “transmitting mode”). The identifying information 210 for the beacon 200 can be replaced with new identifying information; a suitable BLE-enabled device can transmit a signal to the BLE unit 202 which causes the beacon processing unit 204 to initiate logic for receiving new identifying information for the beacon 200 and for writing the new identifying information for the beacon 200 to the beacon storage 206. While shown as separate blocks in FIG. 2 for purposes of illustration, one skilled in the art will appreciate that one or more of the BLE unit 202, beacon processing unit 204 and storage 206 may be integrated into a single unit.

Beacons may include additional components as well. FIG. 2A shows a second exemplary beacon 200A, which is similar to the first exemplary beacon 200 shown in FIG. 2, and in which like references denote like features, but with the suffix “A”. The beacon 200A, in addition to the BLE unit 202A, beacon processing unit 204A, beacon storage 206A and power source 208A, also includes a temperature sensor 212A and a motion sensor 214A (e.g. an accelerometer and/or gyroscope), both coupled to the beacon processing unit 204A. Thus, some beacons may transmit data packets that include additional information beyond the identifying information for the beacon. The temperature sensor 212A and motion sensor 214A are merely examples of additional sensors that may be included as part of a beacon; beacons may be provided with a wide array of additional sensors and components.

There are currently four major published beacon protocols for transmitting the advertisement (the data packet containing the identifying information for the beacon): iBeacon, sBeacon (also referred to as s-beacon), AltBeacon and Eddystone. The iBeacon protocol is promulgated by Apple Inc., having an address at 1 Infinite Loop, Cupertino, Calif., 95014, U.S.A. Information about the iBeacon protocol is available at https://developer.apple.com/ibeacon/. The AltBeacon protocol is promulgated by Radius Networks, Inc., having an address at The Powerhouse, 3255 Grace Street NW, Washington, D.C., 20007, U.S.A. Information about the AltBeacon protocol is available at http://altbeacon.org/. The Eddystone protocol is promulgated by Google Inc., having an address at 1600 Amphitheatre Parkway, Mountain View, Calif., 94043, U.S.A. Information about the Eddystone protocol is available at https://developers.google.com/beacons/?hl=en. The sBeacon protocol was promulgated by Signa1360, Inc. (formerly Sonic Notify Inc.), having an address at 251 5^{th} Ave, 6^{th} Floor, New York City, N.Y., 10016, U.S.A.

Under the present BLE standard the advertisement comprises a 37-octet hexadecimal string which contains identifying information for the beacon. For iBeacon, s-beacon and AltBeacon, the identifying information for the beacon includes a leading sixteen octet universally unique identifier (UUID) for the beacon, followed by one or more identifiers for the beacon. For example, in the iBeacon format promulgated by Apple Inc., the advertisement comprises an octet indicating the overall length of the advertisement, followed by a second octet set to 0xFF, followed by an octet set to 4C00 (the company ID for Apple Inc.), followed by an octet for data type, followed by an octet for length, followed by the sixteen-octet UUID, followed by a first two-octet identifier called “major”, followed by a second two-octet identifier called “minor”, followed by an octet indicating calibration power. In the iBeacon protocol and the sBeacon protocol, the UUID is referred to simply as “UUID”, in the AltBeacon protocol the UUID is referred to as “ID1”; in each case it is a sixteen-octet string and provides the same functionality. In the AltBeacon protocol a first two-octet identifier called “ID2” and a second two-octet identifier called “ID3” follow ID1; in the sBeacon protocol a single string referred to as “SID” follows the UUID. In the Eddystone protocol, the identifying information for the beacon is an eight octet string which includes a leading five-octet UUID referred to as “Namespace” followed by a three octet profile identifier for the beacon, referred to as “Instance”. For simplicity, the term “UUID” is used herein to refer to the leading identifier (e.g. the leading sixteen-octet identifier in the iBeacon, sBeacon and AltBeacon protocols and the leading five-octet “Namespace” identifier in the Eddystone protocol), regardless of the beacon protocol.

Typically, each manufacturer ships its beacons with the identical default UUID, although the identifier(s) may differ (e.g. they may be assigned randomly). The user or installer of the beacons sets the UUID and identifier(s) to appropriate values so that they will be recognized by the logic of the software program executing on the receiving device.

According to the present disclosure, existing sensors on a mobile wireless telecommunication computing device, such as a smartphone, are recruited to cause an action to be initiated in appropriate circumstances, using a wireless signal to identify the desired action. In a preferred embodiment, the wireless signal is transmitted from a nearby beacon, and in such embodiments, the term “mobile wireless telecommunication computing device” will be understood to refer to a BLE-enabled device. The present disclosure describes two basic techniques: (1) a proximity-based technique; and (2) a gesture-based technique; these two techniques can also be combined.

In the proximity-based technique, a user configures his or her mobile wireless telecommunication computing device to carry out an action when the mobile wireless telecommunication computing device detects one or more signals, other than the wireless signal, indicating a close proximity to a particular location (e.g. a beacon transmitting the wireless signal). Thus, in the proximity-based technique the user can cause the mobile wireless telecommunication computing device to initiate the action simply by approaching sufficiently close to a suitably configured beacon. This approach has application in the pull marketing context. For example, a beacon can be located on or near a poster or other advertising material, and a user could indicate his or her interest by approaching the poster or other material. If the user approaches sufficiently closely (e.g. within 2 to 3 feet), the mobile wireless telecommunication computing device will perform an action based on the wireless signal from the beacon. Importantly, in preferred embodiments the sensor or sensors used to indicate the user's proximity do not form part of the wireless communication module of the mobile wireless telecommunication computing device, but are substantially independent thereof; the sensor or sensors used to indicate the user's proximity are not used to receive the wireless signal from the beacon. Even if a user is within range of the relevant beacon and receives the wireless signal from the beacon, the mobile wireless telecommunication computing device will not perform the action unless the sensor(s) also indicate sufficient proximity. Thus, using the beacon and poster example, the mobile wireless telecommunication computing device will only perform the action based on the wireless signal if the user approaches the poster to a viewing distance that indicates interest; if the user simply walks past the poster at a greater distance, the mobile wireless telecommunication computing device will not perform the action even if it receives the wireless signal.

In one specific implementation of the proximity-based technique, referred to herein as a “dwell-based” technique, the mobile wireless telecommunication computing device monitors a period of time during which the mobile wireless telecommunication computing device remains within a predetermined proximity of a suitably configured beacon. In the dwell-based technique, the mobile wireless telecommunication computing device will only perform the action if the mobile wireless telecommunication computing device remains within the predetermined proximity of the beacon for at least a predetermined period of time. The predetermined period of time may be selected by the user, or may be set to a default value, or may be set to different values depending on the application. For example, where a beacon is located on or near a poster, the predetermined period may be used to indicate that the user has stopped to look at the poster, and is not merely walking past it. In another example, a suitably configured beacon may be placed near a checkout queue in a retail store, and the mobile wireless telecommunication computing device may perform an action only if the time (“dwell time”) that the mobile wireless telecommunication computing device is within sufficient proximity to the beacon (indicating that the user of the mobile wireless telecommunication computing device is standing in line) exceeds a predetermined period. In one exemplary implementation, if a user is spending too long in line at a retail establishment, the mobile wireless telecommunication computing device may use its web browser to retrieve a discount coupon by way of “apology” for the length of the wait.

In the gesture-based technique, a user configures his or her mobile wireless telecommunication computing device to carry out an action when one or more sensors on the mobile wireless telecommunication computing device indicate an affirmative physical gesture. Thus, in the gesture-based technique the user can request performance of the action by gesturing with the mobile wireless telecommunication computing device while in range of an appropriate wireless signal (e.g. a signal from a suitably configured beacon). This approach also has application in the pull marketing context. For example, a beacon can be located on or near a poster or other advertising material, and a user could indicate his or her interest by making a predetermined gesture. Again, the sensor(s) used to identify the gesture preferably do not form part of the wireless communication module of the mobile wireless telecommunication computing device, but are substantially independent thereof; the sensor or sensors used to identify the gesture are not used to receive the wireless signal from the beacon. Even if a user is within range of the relevant beacon, the mobile wireless telecommunication computing device will not perform the action based on the wireless signal from the beacon unless the sensor(s) indicate that the user has made the predetermined gesture to initiate the action. Thus, in the poster example, if the user simply walks past the poster, the mobile wireless telecommunication computing device will not perform the action.

The proximity-based technique and the gesture-based technique can be combined; in the combined technique the mobile wireless telecommunication computing device will not act on the wireless signal from the beacon unless the sensors indicate both that the user is sufficiently close to the beacon and also that the user has made the predetermined gesture.

As noted above, both the proximity-based technique and the gesture-based technique have application in the pull marketing context. For example, a movie theatre may position beacons on or near posters advertising films that are currently screening or will soon be screening. A user can approach (proximity-based) a particular poster or gesture toward a particular poster (gesture-based), or both (combined) to cause their networked mobile wireless telecommunication computing device to download and begin playing a trailer for the film advertised by the poster.

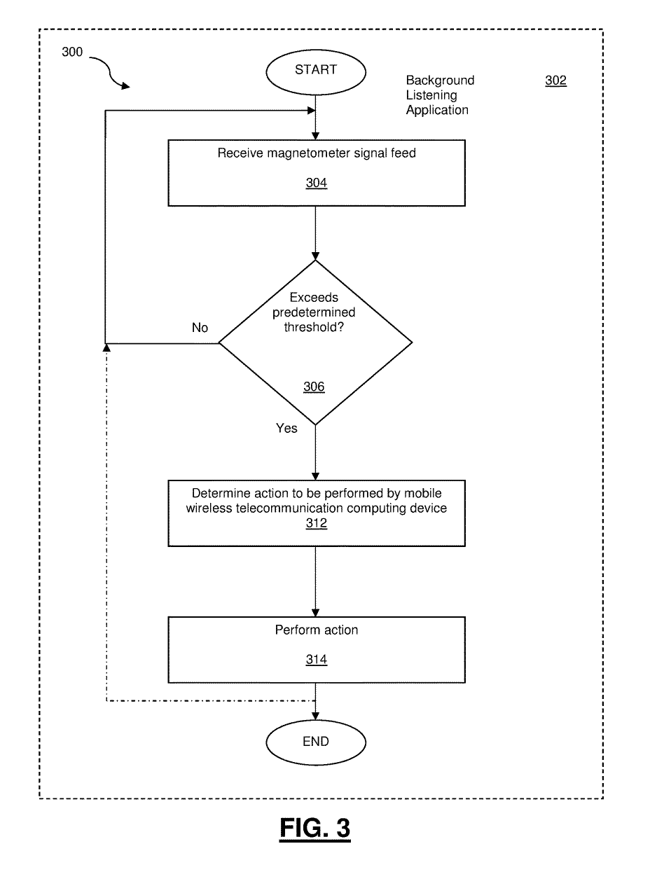

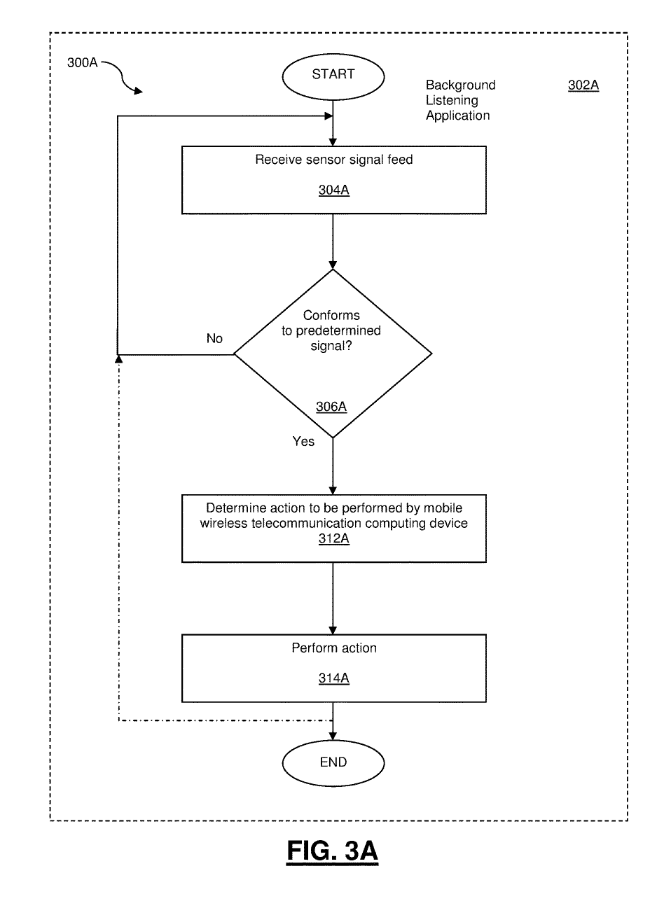

Reference is now made to FIG. 3, which is a flow chart showing a first exemplary method 300 for initiating an action. In the method 300, the sensor used is a magnetometer, and the method 300 is carried out by a mobile wireless telecommunication computing device having a magnetometer and the method 300 implements the proximity-based technique. Examples of suitable mobile wireless telecommunication computing devices include magnetometer-equipped smartphones such as the exemplary smartphone 100 described above, magnetometer-equipped smart-watches and tablets, or any other mobile wireless telecommunication computing device having a suitable magnetometer.

The method 300 is implemented on the mobile wireless telecommunication computing device by a background listening application, denoted schematically by dashed box 302, executing in a processor of the mobile wireless telecommunication computing device (e.g. CPU 110 of smartphone 100 in FIG. 1). The background listening application 302 causes the processor to monitor a magnetometer signal feed from a magnetometer on the mobile wireless telecommunication computing device. The background listening application 302 can be “always on” so that it does not require activation by the user, or may default to “always on” with an option for the user to disable it. Alternatively or additionally, the background listening application 302 may be under the control of the operating system of the mobile wireless telecommunication computing device, and may be activated and/or deactivated based on a variety of factors such as battery level, processor usage, etc. In a preferred embodiment, as a “background” application, the background listening application 302 will not normally be visible to the user of the mobile wireless telecommunication computing device. Using a background listening application with appropriate operating system permissions will enable the action to be performed even if the mobile wireless telecommunication computing device is locked or another application is executing. In other embodiments, a listening application may be manually activated or deactivated by the user.

The background listening application 302 causes the processor to receive the magnetometer signal feed at step 304, and, at step 306, to compare the magnetometer signal feed to a predetermined threshold. The predetermined threshold is designed to detect a magnet of known strength located on or near a beacon so as to function as an indication of proximity to a magnet, and therefore of proximity to the beacon. The predetermined threshold is set to a value high enough to be easily distinguished from the Earth's ambient magnetic field, and also high enough to match the desired proximity, so as to reduce the likelihood of false positives. If the processor determines that the magnetometer signal feed received at step 304 does not exceed the threshold (a “no” at step 306), the processor returns to step 304 to continue receiving magnetometer signal feed. If the processor determines that the magnetometer signal feed received at step 304 exceeds the predetermined threshold (a “yes” at step 306), the background listening application 302 causes the processor to proceed to step 312. Thus, step 312 is responsive to receiving a magnetometer signal in the magnetometer signal feed exceeding the predetermined threshold. Optionally, step 306 may require the magnetometer signal feed to exceed the threshold for a predetermined period of time to generate a “yes”.

At step 312, the background listening application 302 causes the processor to determine an action to be performed by the mobile wireless telecommunication computing device, and then at step 314 the background listening application 302 causes the mobile wireless telecommunication computing device to perform the action. The action may be, for example, to open a web page in a browser on the mobile wireless telecommunication computing device, or to launch another application on the mobile wireless telecommunication computing device.

At step 312, the processor determines the action to be performed by the mobile wireless telecommunication computing device from wireless communication signal received by the mobile wireless telecommunication computing device. In a preferred embodiment, the wireless communication signal is a short-range wireless communication signal received by the mobile wireless telecommunication computing device from a nearest beacon, i.e. a beacon nearest to the mobile wireless telecommunication computing device. The short-range wireless communication signal from the nearest beacon may be an advertisement that contains a beacon identifier (e.g. UUID, major and minor for a beacon using the iBeacon protocol) for the nearest beacon.

If only a single beacon is in range of the mobile wireless telecommunication computing device, that beacon will, by default, be the nearest beacon. If multiple beacons are in range of the mobile wireless telecommunication computing device, the processor may identify the nearest beacon from a plurality of nearby beacons by using known methods. For example, if only one beacon is determined to have “immediate” proximity, or if only one beacon has “near” proximity and no beacon has “immediate” proximity, then that one beacon is the nearest beacon. The nearest beacon may also be determined by triangulation. In addition, the battery power of a beacon may be adjusted to limit its range.

Thus, in a preferred embodiment, at step 312 the processor determines the action to be performed by the mobile wireless telecommunication computing device from the beacon identifier. For example, the processor may use the beacon identifier to identify the action to be performed from a database. The database may be a local database residing on the mobile wireless telecommunication computing device or, if the mobile wireless telecommunication computing device is coupled to a network, the database may be a remote database coupled to the network. The database may be a simple lookup table with one-to-one correspondence between the beacon identifier and the action to be performed, or may be a more complicated database for which further information, in addition to the beacon identifier, is used to identify the action to be performed. For example, the further information may include location information, previously obtained information such as preference information, personal demographic information, and so on. The further information may be provided directly by a user, or may be obtained, inferred or extrapolated from related sources, such as from a user's social media accounts. In an embodiment where the mobile wireless telecommunication computing device is coupled to a network, the further information may also include an identifier and/or MAC address for the mobile wireless telecommunication computing device, which may be used, in addition to the beacon identifier (and possibly other information) to identify the action to be performed from the database.

In one preferred embodiment, the action that is determined at step 312 and performed at step 314 consists of a predetermined operation performed using at least one predetermined value, and the processor identifies the predetermined value(s) (and possibly other information) from the database. In one particularly preferred embodiment where the mobile wireless telecommunication computing device is networked, the predetermined operation is opening a web page in a browser and the predetermined value is a uniform resource locator (URL). In such an embodiment, the processor uses the beacon identifier in the advertisement from the nearest beacon to retrieve a URL from the database, and then uses the browser on the networked mobile wireless telecommunication computing device to open the web page identified by that URL. The predetermined operation may also be to download (and possibly open) a file, and the predetermined value may be a file name or file path (either a local or a network file path). A second predetermined value may identify an application to be used to open the file. An audible notification may be provided when the web page or file has loaded, or the file may be an audio or video file which plays once loaded. Another example of a predetermined operation is opening an application on the mobile wireless telecommunication computing device and the predetermined value is a data set acted upon by the application. For example, the application may be a thermostat control application and the data set may be a desired temperature, or the application may be light control application and the data set may denote a set of lights to be turned on (or off). The application may also be a media player and the data set may specify one or more local or remote media files (e.g. audio or video) to be retrieved and played by the media player. Additionally, the predetermined action may be to open a self-contained application (e.g. a game) and the predetermined value may specify the application to be opened.

After performing the action at step 314, the method 300 ends or, alternatively (as shown by the dashed arrow line) returns to step 304 to continue monitoring the magnetometer signal feed.

Thus, method 300 enables a user to initiate an action, which may be a pull marketing request, by approaching sufficiently close to a beacon that includes, or is positioned in close proximity to, a sufficiently powerful magnet. This results in a desired action, such as opening a web page corresponding to advertising material with which a beacon is associated.

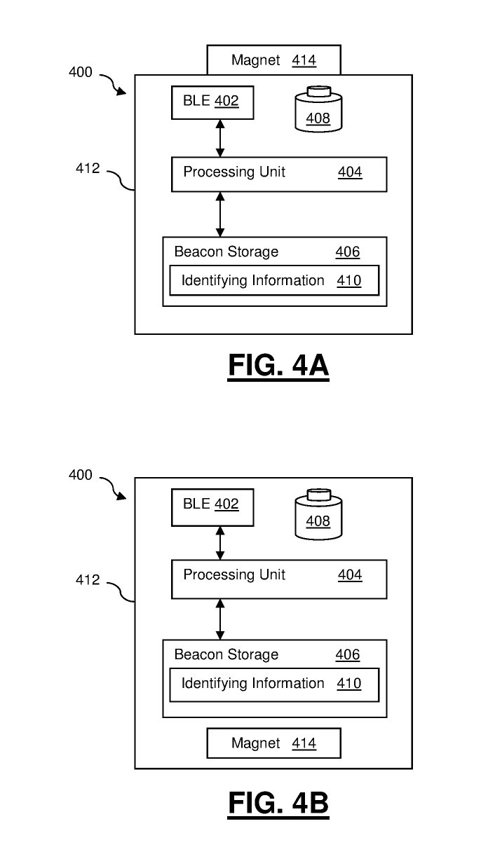

Reference is now made to FIGS. 4A and 4B, each of which shows an exemplary beacon 400. The beacons 400 are similar to the beacon 200 shown in FIG. 2, and comprise a BLE unit 402 adapted to send and receive BLE radio signals, a beacon processing unit 404 coupled to the BLE unit 402 to control the BLE unit 402, a beacon storage 406 coupled to the beacon processing unit 404 and a power source 408 to power the beacon. Identifying information 410 for the beacon 400 is stored in the beacon storage. The BLE unit 402, beacon processing unit 404, beacon storage 406 and power source 408 are all carried by a housing 412; in the illustrated embodiment, the BLE unit 402, beacon processing unit 404, beacon storage 406 and power source 408 are all contained within the housing. The exemplary beacons 400 shown in FIGS. 4A and 4B each further comprise a magnet 414 carried by the housing 412; this magnet 414 is additional to, and separate from, any magnetic component(s) in the BLE unit 402. The Earth's ambient magnetic field is between 25 to 65 microteslas (0.25 to 0.65 gauss) depending on location; in the illustrated embodiment the magnet 414 has a strength of at least 70 microteslas (0.70 gauss), more preferably at least 75 microteslas (0.75 gauss) and still more preferably at least 85 microteslas (0.85 gauss) to allow it to be distinguished from the Earth's ambient magnetic field with sufficient confidence. In the embodiment shown in FIG. 4A, the magnet 414 is carried externally of the housing 412, and hence a beacon 400 as shown in FIG. 4A may be constructed by affixing a suitable magnet to a conventional beacon. In the embodiment shown in FIG. 4B, the magnet 414 is carried within the housing 412. The exemplary beacons 400 shown in FIGS. 4A and 4B may be used in association with the exemplary method 300 described above.

Since step 306 determines whether the mobile wireless telecommunication computing device is close enough to the magnet (e.g. magnet 414) to indicate sufficient proximity (in the exemplary embodiment, proximity to the associated beacon), it is an example of the proximity-based approach. Another proximity-based approach uses a method identical to the method 300 except with a light sensor instead of the magnetometer, and a beacon or other wireless signal source may be placed in a location having specialized lighting so that proximity to the beacon may be detected via the signal from the light sensor.

The exemplary method 300 is a particular implementation of a method in which a background listening application causes the processor to monitor a single sensor signal feed from a single sensor on the mobile wireless telecommunication computing device. Responsive to receiving a predetermined signal in the sensor signal feed, the method will determine an action to be performed by the mobile wireless telecommunication computing device from a wireless communication signal received by the mobile wireless telecommunication computing device (e.g. an advertisement from a nearest beacon), and cause the mobile wireless telecommunication computing device to perform the action. Using the magnetometer or the light sensor makes this an implementation of the proximity-based approach. Using a sensor associated with movement of the mobile wireless telecommunication computing device, such as an accelerometer or a gyroscope, would make the method an implementation of the gesture-based approach. For example a user could “shake” the mobile wireless telecommunication computing device, and this gesture could be detected by the accelerometer alone. Additionally, a gesture-based approach may be implemented using the magnetometer by selecting a magnet of such strength that the user must place the mobile wireless telecommunication computing device very close to the magnet to enable to magnetometer to distinguish the field from the magnet from the earth's ambient magnetic field. In such an embodiment, the magnet is preferably of such a strength that the mobile wireless telecommunication computing device must be positioned such that its magnetometer is within 10 centimeters from the magnet to distinguish it from the earth's ambient magnetic field. More preferably, the magnet is of such a strength that the mobile wireless telecommunication computing device must be positioned such that its magnetometer is within 5 centimeters from the magnet to distinguish it from the earth's ambient magnetic field. Still more preferably, the magnet is of such a strength that the mobile wireless telecommunication computing device must be positioned such that its magnetometer is within 3 centimeters from the magnet to distinguish it from the earth's ambient magnetic field, and even more preferably the magnet is of such a strength that the mobile wireless telecommunication computing device must be positioned such that its magnetometer is within 1 centimeter from the magnet to distinguish it from the earth's ambient magnetic field. Thus, the user must affirmatively gesture toward the magnet with the mobile wireless telecommunication computing device to initiate the action.

As noted above, the exemplary method 300 is a particular implementation of a method in which a background listening application causes the processor to monitor a single sensor signal feed from a single sensor on the mobile wireless telecommunication computing device. Reference is now made to FIG. 3A, which is a flow chart showing a more generalized implementation of a method 300A in which a background listening application causes the processor to monitor a single sensor signal feed from a single sensor on the mobile wireless telecommunication computing device to determine whether to initiate an action. Thus, the exemplary method 300 shown in FIG. 3 is a specific implementation of the method 300A shown in FIG. 3A in which the single sensor is a magnetometer. Accordingly, corresponding reference numerals denote corresponding features/steps, with the suffix “A” added for the method 300A shown in FIG. 3A, and details described in respect of the exemplary method 300 shown in FIG. 3, other than those relating specifically to the magnetometer, are also applicable to the method 300A shown in FIG. 3A and for the sake of brevity are not repeated.

The method 300A is implemented by a background listening application, denoted schematically by dashed box 302A, executing in a processor of the mobile wireless telecommunication computing device (e.g. CPU 110 of smartphone 100 in FIG. 1). The background listening application 302A causes the processor to monitor a sensor signal feed from a single sensor, other than a camera, on the mobile wireless telecommunication computing device. It is important that the sensor be a sensor other than a camera on the mobile wireless telecommunication computing device because the image processing associated with monitoring a camera feed tends to consume substantial processing resources and could lead to premature battery drain. The background listening application 302A causes the processor to receive the sensor signal feed at step 304A, and, at step 306A, to compare the sensor signal feed to a predetermined signal to assess whether the sensor signal feed conforms to the predetermined signal. The predetermined signal may be a threshold value (e.g. a magnetic field strength), a spectrum location or a waveform or other pattern. For example, the predetermined signal may be a signal expected from an accelerometer or a gyroscope when a certain gesture is performed. Conformity between the sensor signal feed to a predetermined signal does not necessarily require an exact match, but merely sufficient conformity to reduce the likelihood of error (i.e. falsely identifying an event, such as a gesture, that that has not actually occurred) to acceptable levels in the particular application. Optionally, step 306A may require the predetermined signal to persist for a predetermined period of time, or the predetermined signal may incorporate a predetermined period of time therein. If the processor determines that the sensor signal feed received at step 304A does not conform to the predetermined signal (a “no” at step 306A), the processor returns to step 304A to continue receiving the sensor signal feed. If the processor determines that the sensor signal feed received at step 304A conforms to the predetermined signal (a “yes” at step 306A), the background listening application 302A causes the processor to proceed to step 312A. Thus, step 312A is responsive to receiving a sensor signal in the sensor signal feed conforming to the predetermined signal.

At step 312A, the background listening application 302A causes the processor to determine an action to be performed by the mobile wireless telecommunication computing device, and then at step 314A the background listening application 302A causes the mobile wireless telecommunication computing device to perform the action. After performing the action at step 314A, the method 300A ends or, alternatively (as shown by the dashed arrow line) returns to step 304A to continue monitoring the sensor signal feed.

When using only a single sensor feed, the proximity-based technique using the magnetometer (i.e. the method 300) is preferred because it provides a low likelihood of a false positive at step 306. In other embodiments, the risk of false positives can be reduced by using input from two or more sensors. In such embodiments, the background listening application causes the processor to monitor at least a first sensor signal feed from a first sensor on the mobile wireless telecommunication computing device and a second sensor signal feed from a second sensor on the mobile wireless telecommunication computing device.

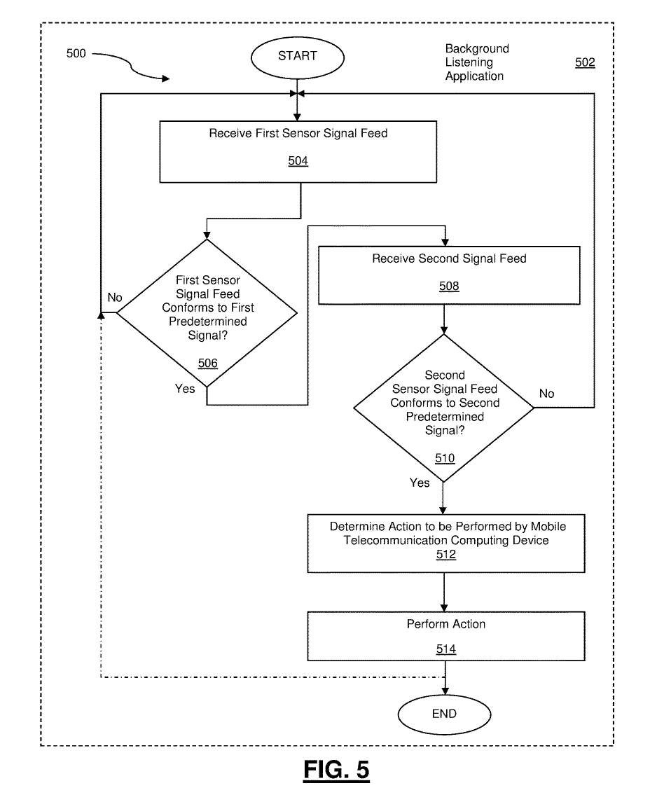

Reference is now made to FIG. 5, which is a flow chart showing a second exemplary method 500 for initiating an action. As with the first exemplary method 300, the second exemplary method 500 is carried out by a mobile wireless telecommunication computing device such as a smartphone (e.g. exemplary smartphone 100 described above), smart-watch or tablet, among others, and is implemented by a background listening application 502 executing in a processor of the mobile wireless telecommunication computing device. The background listening application 302 causes the processor to monitor at least a first sensor signal feed from a first sensor on the mobile wireless telecommunication computing device and a second sensor signal feed from a second sensor on the mobile wireless telecommunication computing device. The first and second sensor may be, for example, any two of the magnetometer, accelerometer, gyroscope, light sensor and microphone but preferably do not include the camera(s).

The background listening application 502 causes the processor to receive the first sensor signal feed at step 504, and, at step 506, to compare the first sensor signal feed to a first predetermined signal. If the processor determines that the first sensor signal feed received at step 504 does not conform to the first predetermined signal (a “no” at step 506), the processor returns to step 504 to continue receiving the first sensor signal feed. If the processor determines that the first sensor signal feed received at step 504 conforms to the first predetermined signal (a “yes” at step 506), the background listening application 502 causes the processor to proceed to step 508. At step 508, the background listening application 502 causes the processor to receive the second sensor signal feed for a predetermined time interval corresponding to the first sensor signal feed received at step 504, and, at step 510, to compare the second sensor signal feed to a second predetermined signal. If the processor determines that the second sensor signal feed received at step 508 does not conform to the second predetermined signal (a “no” at step 510), the processor returns to step 504 to again check the first sensor signal feed. If the processor determines that the second sensor signal feed received at step 508 conforms to the second predetermined signal (a “yes” at step 510), the background listening application 502 causes the processor to proceed to step 512.

Steps 504 to 510 may be performed in any suitable order as long as step 504 is performed before step 506 and step 508 is performed before step 510. For example, step 508 may be performed immediately after step 504 and a “yes” at step 506 may cause the method 500 to proceed from step 506 to 510. Alternatively, steps 504 and 508 and/or steps 506 and 510 may be performed substantially simultaneously. The purpose of steps 504 to 510 is to determine whether, for a first sensor feed and a second sensor feed received within a predetermined time interval of one another, both the first sensor signal feed and the second sensor signal feed conform, respectively, to the first and second predetermined signals. Thus, the method 500 proceeds to step 512 only responsive to receiving both a first predetermined signal in the first sensor signal feed (“yes” at step 506) and a second predetermined signal in the second sensor signal feed (“yes” at step 510). The first and second predetermined signals can incorporate thresholds, ranges and/or patterns.

The first and second predetermined signals can be set to a combination that is unlikely to occur without an intentional act by the user of the mobile wireless telecommunication computing device. For example, the first and second sensor may be the accelerometer and gyroscope of the mobile wireless telecommunication computing device, and the first and second predetermined signals can be those resulting from a predefined gesturing action by the user while holding the mobile wireless telecommunication computing device. For example, if a user, while holding the mobile wireless telecommunication computing device, reaches out and then pulls back (i.e. a “pull” gesture), this will produce a characteristic signal in each of the accelerometer and the gyroscope of the mobile wireless telecommunication computing device. The first and second predetermined signals can be set to match these signals (or to a range encompassing expected values for those signals), so that when a user makes this “pull” gesture while holding the mobile wireless telecommunication computing device with the background listening application 502 running, the method 500 will produce a “yes” at steps 506 and 510. Of course, the above-described “pull” gesture is merely one exemplary gesture, and any suitable gesture may be used. For example, a user may move the mobile wireless telecommunication computing device though a circular path, or shake the mobile wireless telecommunication computing device. The user may also be permitted to define their own gesture. Preferably, the gesture is one for which the characteristic signal in each of the accelerometer and the gyroscope of the mobile wireless telecommunication computing device is unlikely to occur absent deliberate performance of the gesture.

As noted above, the method 500 proceeds to step 512 only responsive to receiving both a first predetermined signal in the first sensor signal feed (“yes” at step 506) and a second predetermined signal in the second sensor signal feed (“yes” at step 510). At step 512, the background listening application 502 causes the processor to determine an action to be performed by the mobile wireless telecommunication computing device, and then at step 514 the background listening application 502 causes the mobile wireless telecommunication computing device to perform the action. Step 512 uses a wireless communication signal received by the mobile wireless telecommunication computing device (e.g. an advertisement from a nearest beacon), and may use a local or a remote database (e.g. using a beacon identifier, and possibly other information, to determine the action from the database). The action performed at step 514 may consist of a predetermined operation performed using a predetermined value determined from the database (e.g. open a specified web page in a browser, download and open a specified file, etc.). Steps 512 and 514 are analogous to steps 312 and 314 of the first exemplary method 300 and may be carried out in a similar manner and therefore for brevity steps 512 and 514 are not discussed further.

After step 514, the method 500 ends or, alternatively (as shown by the dashed arrow line) returns to step 504 to continue monitoring the first sensor signal feed.

One preferred embodiment of the method 500 uses the accelerometer and the gyroscope as the first and second sensors; both of these sensors are associated with detecting movement of the mobile wireless telecommunication computing device and hence this is an instance of the gesture-based technique. However, it is not necessary that both the first and second sensor be associated with detecting movement of the mobile wireless telecommunication computing device. For example, where the beacon used incorporates a magnet (e.g. beacon 400 shown in FIGS. 4A and 4B described above) the first and second sensors may be the magnetometer and the accelerometer or the magnetometer and the gyroscope, so as to detect a suitable gesture carried out in the presence of a sufficiently strong magnetic field. These examples represent combinations of the proximity-based technique and the gesture-based technique. In further embodiments, neither the first sensor nor the second sensor is associated with detecting movement of the mobile wireless telecommunication computing device. For example, a beacon incorporating a magnet (e.g. beacon 400 shown in FIGS. 4A and 4B described above) may be placed in a location having specialized lighting, and the first and second sensor may be the magnetometer and the light sensor. This would be an example of the proximity-based technique.

Moreover, while the exemplary method 500 utilizes two sensors, methods according to the present disclosure may be adapted to three or more sensors, so that the processor will determine an action to be performed, and perform the action, when it receives predetermined signals from all of those sensors.

Conceptually, the sensors on a mobile wireless telecommunication computing device may be categorized as passive sensors, interactive sensors, and switches. A “passive sensor” is one which, when active, constantly monitors an ambient external stimulus and sends a sensor signal feed representing the ambient external stimulus to the processor without requiring any physical interaction with the mobile wireless telecommunication computing device by the user. The magnetometer, accelerometer, gyroscope, light sensor, microphone and camera are examples of passive sensors. An interactive sensor is one which, when active, monitors a user's physical interaction with the mobile wireless telecommunication computing device. The most common example of an interactive sensor on a mobile wireless telecommunication computing device is a capacitive touch screen. A switch, although also detecting a user's physical interaction with the mobile wireless telecommunication computing device, is distinct from an interactive sensor because a switch detects only discrete states (e.g. a button is either pressed or not pressed). Examples of switches may include the “home” button, “off” or “lock screen” buttons, keyboard buttons and volume control buttons. Moreover, although a user's physical interaction with the mobile wireless telecommunication computing device may be detected by a passive sensor, passive sensors are not limited to detecting such physical interaction. For example, an accelerometer and gyroscope will sense the motion of a user travelling in an automobile even if the mobile wireless telecommunication computing device is in the user's pocket, whereas a capacitive touch screen is designed to only detect a user's physical interaction.

Preferably, in the methods described herein, the sensor signal feeds are only from passive sensors, although some embodiments are contemplated in which the sensor signal feed or feeds include sensor signal feed(s) from interactive sensors and/or switches. For example, in one embodiment the first predetermined signal may be pressing the “home” button (a switch) to present a “lock screen” on the display of the mobile wireless telecommunication computing device and the second predetermined signal may be pressing a second physical button (a switch) or performing an action on a touch screen (an interactive sensor) such as swiping or pressing a virtual button.

It is also preferable that the sensors used in the methods described herein do not include the location processor, although again some embodiments are contemplated in which a sensor signal feed from a location processor is used. For example, the first predetermined signal may be a sensor signal feed from the location processor that the mobile wireless telecommunication computing device is within a particular geographic region (e.g. proximate to a particular business) and the second predetermined signal may be a sensor signal feed from the accelerometer indicating that the user has “shaken” or performed another gesture with the mobile wireless telecommunication computing device.

Furthermore, the above-described methods are not limited to sensors presently incorporated into mobile wireless telecommunication computing devices, and may be extended to any suitable sensors that may in the future be incorporated into mobile wireless telecommunication computing devices, whether such sensors are now known or are developed in the future. Again such sensors are preferably sensors other than those incorporated into the wireless communication systems of the mobile wireless telecommunication computing device; preferably the sensor or sensors used to identify the gesture or indicate the user's proximity are not used to receive the wireless signal from the beacon. Although the term “wireless communication module” as used herein does not include or encompass a magnetometer, it may be possible to use the magnetometer of a smartphone to receive data encoded in a magnetic field. For example, the paper entitled “Pulse: Low Bitrate Wireless Magnetic Communication for Smartphones” by Weiwei Jiang, Denzil Ferreira, Jani Ylioja, Jorge Goncalves and Vassilis Kostakos describes encoding data in magnetic fields for communication to a smartphone via its magnetometer. If a magnetometer is used to determine an action to be performed by the mobile wireless telecommunication computing device based on data encoded in a magnetic field, the magnetometer is preferably excluded from the sensor, or set of sensors, whose sensor signal feed is monitored by the listening application.

Although beacons represent a preferred source of a wireless communication signal that can be used to determine an action to be performed by the mobile wireless telecommunication computing device, they are not the only such source. Suitable wireless communication signals may also be transmitted via WiFi, conventional (non-BLE) Bluetooth or audio signals (e.g. an audio signal above or below human hearing but which can be detected by a microphone on the mobile wireless telecommunication computing device).

As can be seen from the above description, the technology described herein represents significantly more than merely using categories to organize, store and transmit information and organizing information through mathematical correlations. The methods for initiating an action are in fact an improvement to the technology of mobile wireless telecommunication computing devices, as they provide an improved methodology for initiation of actions by a mobile wireless telecommunication computing device by leveraging additional sensors to determine when an action is to be initiated in combination with wireless communication to determine the action to be performed. The exemplary beacons described herein are likewise an improvement to the technology of beacons by providing an additional independent feature that can be detected by a mobile wireless telecommunication computing device. Moreover, the present technology is applied by using particular machines, namely beacons (in one aspect) and mobile wireless telecommunication computing devices (in another aspect). As such, the present technology is in one aspect confined to beacons and is in another aspect confined to mobile wireless telecommunication computing devices.

Aspects of the present technology may be embodied within a system, a method, a computer program product or any combination thereof. The computer program product may include a computer readable storage medium or media having computer readable program instructions thereon for causing a processor to carry out aspects of the present technology. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices, such as a mobile wireless telecommunication computing device, from a computer readable storage medium or via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Aspects of the present technology have been described above with reference to flowchart illustrations and/or block diagrams of methods, apparatus (systems) and computer program products according to various embodiments. In this regard, the flowchart and block diagrams in the Figures illustrate the architecture, functionality, and operation of possible implementations of systems, methods and computer program products according to various embodiments of the present technology. For instance, each block in the flowchart or block diagrams may represent a module, segment, or portion of instructions, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Some specific examples of the foregoing may have been noted above but any such noted examples are not necessarily the only such examples.

It also will be understood that each block of the flowchart illustrations and/or block diagrams, and combinations of blocks in the flowchart illustrations and/or block diagrams, can be implemented by computer program instructions. These computer program instructions may be provided to a processor of a mobile wireless telecommunication computing device to produce a machine, such that the instructions, which execute via the processor of the mobile wireless telecommunication computing device, create means for implementing the functions/acts specified in the flowchart and/or block diagram block or blocks.

These computer program instructions may also be stored in a computer readable medium that can direct a mobile wireless telecommunication computing device to function in a particular manner, such that the instructions stored in the computer readable medium produce an article of manufacture including instructions which implement the function/act specified in the flowchart and/or block diagram block or blocks. The computer program instructions may also be loaded onto a mobile wireless telecommunication computing device to cause a series of operational steps to be performed on the mobile wireless telecommunication computing device to produce a computer implemented process such that the instructions which execute on the computer or other programmable apparatus provide processes for implementing the functions/acts specified in the flowchart and/or block diagram block or blocks.

The term “computer system” and related terms, as used herein, is not limited to any particular type of computer system or architecture, and similarly the term “mobile wireless telecommunication computing device” is not limited to any specific system or device and encompasses devices such as smartphones, smart watches, tablet computers, among others.

Thus, computer readable program code for implementing aspects of the technology described herein may be contained or stored in the memory 112 of the onboard computer system 106 of the smartphone 100, or on a computer usable or computer readable medium external to the onboard computer system 106 of the smartphone 100, or on any combination thereof.

Finally, the terminology used herein is for the purpose of describing particular embodiments only and is not intended to be limiting. As used herein, the singular forms “a”, “an” and “the” are intended to include the plural forms as well, unless the context clearly indicates otherwise. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Conditional language such as, among others, “can,” “could,” “might” or “may,” unless specifically stated otherwise, are otherwise understood within the context as used in general to present that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y or Z,” unless specifically stated otherwise, is otherwise understood with the context as used in general to present that an item, term, etc., may be either X, Y or Z, or any combination thereof (e.g., X, Y and/or Z). Thus, such disjunctive language is not generally intended to, and should not, imply that certain embodiments require at least one of X, at least one of Y or at least one of Z to each be present.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the form disclosed. Many modifications and variations will be apparent to those of ordinary skill in the art without departing from the scope of the claims. The embodiment was chosen and described in order to best explain the principles of the technology and the practical application, and to enable others of ordinary skill in the art to understand the technology for various embodiments with various modifications as are suited to the particular use contemplated.

One or more currently preferred embodiments have been described by way of example. It will be apparent to persons skilled in the art that a number of variations and modifications can be made without departing from the scope of the claims. In construing the claims, it is to be understood that the use of a mobile wireless telecommunication computing device to implement certain embodiments described herein is essential.

What is claimed is:

1. A method for initiating an action, comprising:
executing, in a processor of a mobile wireless telecommunication computing device, a listening application;
the listening application causing the processor to monitor a sensor signal feed from a sensor on the mobile wireless telecommunication computing device;
the sensor being other than a camera;
the listening application causing the processor to, responsive to receiving a sensor signal in the sensor signal feed conforming to a predetermined signal:
determine an action to be performed by the mobile wireless telecommunication computing device;
wherein the processor determines the action to be performed by the mobile wireless telecommunication computing device from a wireless communication signal received by the mobile wireless telecommunication computing device; and
cause the mobile wireless telecommunication computing device to perform the action.

2. The method of claim 1, wherein:
the sensor signal feed is a magnetometer signal feed from a magnetometer on the mobile wireless telecommunication computing device; and
the predetermined signal is exceeding a predetermined magnetometer threshold.

3. The method of claim 1, wherein:
the wireless communication signal is a short-range wireless communication signal received from a nearest beacon;
the short-range wireless communication signal contains a beacon identifier for the nearest beacon; and
the processor determines the action to be performed by the mobile wireless telecommunication computing device from the beacon identifier.

4. The method of claim 3, wherein the processor determines the action to be performed by the mobile wireless telecommunication computing device from the beacon identifier by using the beacon identifier to identify the action to be performed by the mobile wireless telecommunication computing device from a database.

5. The method of claim 3, wherein:
the mobile wireless telecommunication computing device is coupled to a network; and
the database is a remote database coupled to the network.

6. The method of claim 5, wherein the processor further uses an identifier for the mobile wireless telecommunication computing device to identify the action to be performed by the mobile wireless telecommunication computing device from the database.

7. The method of claim 4, wherein:
the action consists of a predetermined operation performed using at least one predetermined value; and
the processor identifies at least the at least one predetermined value from the database.

8. The method of claim 7, wherein:
the predetermined operation is opening a web page in a browser; and
the predetermined value is a uniform resource locator (URL).

9. The method of claim 3, wherein the processor identifies the nearest beacon from a plurality of nearby beacons by triangulation.

10. A beacon, the beacon comprising:
a housing, the housing carrying:
a BLUETOOTH® Low Energy technology (BLE) unit;
a beacon processing unit coupled to the BLE unit and adapted to control the BLE unit;
a beacon storage coupled to the beacon processing unit, wherein the beacon storage stores an identifier for the beacon;
a power source adapted to power the beacon; and
a magnet having a strength of at least 70 microteslas.

11. The beacon of claim 10, wherein the magnet has a strength of at least 75 microteslas.

12. The beacon of claim 10, wherein the magnet has a strength of at least 85 microteslas.

13. A method for initiating an action, comprising:
executing, in a processor of a mobile wireless telecommunication computing device, a listening application;
the listening application causing the processor to monitor at least a first sensor signal feed from a first sensor on the mobile wireless telecommunication computing device and a second sensor signal feed from a second sensor on the mobile wireless telecommunication computing device;
the first sensor and the second sensor selected from the group consisting of magnetometer, accelerometer, gyroscope, light sensor, microphone, location processor and excluding camera; and
the listening application causing the processor to, responsive to receiving at least a first predetermined signal in the first sensor signal feed and a second predetermined signal in the second sensor signal feed:
determine an action to be performed by the mobile wireless telecommunication computing device;
wherein the processor determines the action to be performed by the mobile wireless telecommunication computing device from a wireless communication signal received by the mobile wireless telecommunication computing device; and
cause the mobile wireless telecommunication computing device to perform the action.

14. The method of claim 13, wherein:
the wireless communication signal is a short-range wireless communication signal received from a nearest beacon;
the short-range wireless communication signal contains a beacon identifier for the nearest beacon; and
the processor determines the action to be performed by the mobile wireless telecommunication computing device from the beacon identifier.

15. The method of claim 14, wherein the processor identifies the nearest beacon from a plurality of nearby beacons by triangulation.

16. The method of claim 13, wherein the processor determines the action to be performed by the mobile wireless telecommunication computing device from the beacon identifier by using the beacon identifier to identify the action to be performed by the mobile wireless telecommunication computing device from a database.

17. The method of claim 16, wherein:
the mobile wireless telecommunication computing device is coupled to a network; and
the database is a remote database coupled to the network.

18. The method of claim 17, wherein the processor further uses an identifier for the mobile wireless telecommunication computing device to identify the action to be performed by the mobile wireless telecommunication computing device from the database.

19. The method of claim 16, wherein:
the action consists of a predetermined operation performed using at least one predetermined value; and
the processor identifies at least the at least one predetermined value from the database.

20. The method of claim 19, wherein:
the predetermined operation is opening a web page in a browser; and
the predetermined value is a uniform resource locator (URL).
